(19) United States
(12) Patent Application Publication
(10) Pub. No.: US 2024/0084101 A1
(43) Pub. Date: Mar. 14, 2024

(54) FORMALDEHYDE-FREE MINERAL WOOL GROWING MEDIA

(71) Applicant: Owens Corning Intellectual Capital, LLC, Toledo, OH (US)

(72) Inventors: Monica Navarreto Lugo, New Albany, OH (US); Liang Chen, New Albany, OH (US); Kate Barnwell, Grosse Pointe, MI (US); Thomas Blaine, Fremont, OH (US); Saul Salgado, Warsaw, IN (US); Holly Avins, Columbus, OH (US); Xiujuan Zhang, New Albany, OH (US)

(21) Appl. No.: 18/466,063

(22) Filed: Sep. 13, 2023

Related U.S. Application Data
(60) Provisional application No. 63/406,484, filed on Sep. 14, 2022.

(51) Int. Cl. C08K 5/17; C08F 8/30

(52) U.S. Cl. CPC C08K 5/17; C08F 8/30

(57) ABSTRACT

Various exemplary aspects are directed to mineral wool plant substrates comprising mineral wool fibers bound by a binder formed from an aqueous binder composition comprising a cross-linking agent comprising at least two carboxylic acid groups; a polyol component having at least two hydroxyl groups; a nitrogen-based protective agent; and from 0.05 wt. % to 0.7 wt. % of a non-ionic surfactant. Methods of manufacturing such fiber-based plant substrates can include collecting a plurality of inorganic fibers on a substrate; applying an aqueous binder composition to the collection of inorganic fibers, forming binder-coated inorganic fibers; and curing the aqueous binder composition at a temperature less than 510° F., thereby forming a fiber-based plant substrate, wherein said aqueous binder composition is free of formaldehyde.

### CROSS-REFERENCE TO RELATED APPLICATIONS

This application claims priority to and the benefit of U.S. Provisional Application No. 63/406,484, filed Sep. 14, 2022, the entire contents of which is incorporated by reference herein.

### FIELD

This disclosure relates to mineral wool growing media and, more specifically, mineral wool growing media that is free of formaldehyde for use in agricultural crop or plant applications.

### BACKGROUND

Substrates, such as those in the form of plugs, blocks, and slabs, for supporting the growth of plants in the absence of soil are known in the art. For example, U.S. Pat. No. 6,389,748, the entire disclosure of which is incorporated by reference herein, discloses a cube having a laminated structure of mineral wool fibers oriented in parallel to one another. The mineral wool fibers are held together by a cured binding agent to form the cube. One such conventional cube is a laminated structure of zigzagged layers of fibers, with a plant opening formed in an upper surface of the cube and a plurality of grooves formed in a lower surface of the cube. The plant opening is shaped and sized to receive a plug containing a seed that has already started the growth process. The cube is sized to allow for the continued soilless growth of the plant.

Water and nutrients are typically delivered to the cube by applying (e.g., dripping) a source of feed water onto the upper surface of the cube. This nutrient-containing feed water propagates through the cube in such a manner that it can be absorbed by the root system of the plant. The excess feed water eventually reaches the lower surface of the cube where the grooves facilitate drainage thereof.

Mineral fiber products generally comprise man-made vitreous fibers (MMVF), such as, for example, glass fibers, ceramic fibers, basalt fibers, slag wool, mineral wool, and stone wool, which are bound together by a polymeric binder composition. Traditional binder compositions used for mineral fiber insulation are based on phenol-formaldehyde (PF) resins, as well as PF resins extended with urea (PUF resins). However, while such binder compositions provide suitable properties to the growing media, binder compositions containing formaldehyde can have various drawbacks, including a risk of the leachate of formaldehyde being taken up by the plants, preventing products formed therewith from being labeled “organic”, and environmental considerations.

As an alternative to formaldehyde-based binders, certain formaldehyde-free formulations have been developed for use as a binder in horticultural products. However, existing formaldehyde-free binders tend to lack the strength of PF binder when used with mineral wool and products formed therefrom demonstrate insufficient performance, particularly with respect to puncture resistance, compression, and bond strength.

Accordingly, there is a need for mineral wool growing media formed using a formaldehyde-free binder composition that maintains sufficient performance properties.

### SUMMARY

Various exemplary aspects of the inventive concepts are directed to mineral wool plant substrates comprising mineral wool fibers bound by a binder formed from an aqueous binder composition comprising a cross-linking agent comprising at least two carboxylic acid groups; a polyol component having at least two hydroxyl groups; a nitrogen-based protective agent; and from 0.05 wt. % to 0.7 wt. % of a non-ionic surfactant.

In certain embodiments, the non-ionic surfactant comprises an ethoxylated propoxylated polyarylphenol ether. In certain embodiments, the nitrogen-based protective agent comprises at least one of an amine-based protective agent or an ammonium based protective agent. In certain embodiments, the mineral wool plant substrate is substantially free of formaldehyde. In certain embodiments, the mineral wool plant substrate has a density in the range of 30 kg/m³ to 150 kg/m³.

In certain embodiments, the mineral wool plant substrate has a loss on ignition of from 1.0% to 5.0%. In certain embodiments, the mineral wool plant substrate exhibits a bond strength of from about 150 lb/ft² to about 250 lb/ft². In certain embodiments, the mineral wool plant substrate exhibits a sink time of less than 30 seconds for a 6 pcf product. In certain embodiments, the mineral wool plant substrate exhibits a water absorption of greater than 50%.

In certain embodiments, the mineral wool plant substrate exhibits a compressive strength of at least 100 lb/ft². In certain embodiments, the mineral wool plant substrate exhibits a puncture resistance of at least 2.5 lb/ft².

In certain embodiments, a method of manufacturing a fiber-based plant substrate is provided. The method can include collecting a plurality of inorganic fibers on a substrate; applying an aqueous binder composition to the collection of inorganic fibers, forming binder-coated inorganic fibers; and curing the aqueous binder composition at a temperature less than 510° F., thereby forming a fiber-based plant substrate, wherein said aqueous binder composition is free of formaldehyde. In certain embodiments, the aqueous binder composition comprises a crosslinking agent comprising at least two carboxylic acid groups; a polyol component having at least two hydroxyl groups; a nitrogen-based protective agent, wherein said nitrogen-based protective agent comprises at least one of an amine-based protective agent or an ammonium based protective agent; and from 0.05 to 0.7 wt % of a non-ionic surfactant, based on a total weight of the aqueous binder composition;

In certain embodiments, the polyol component comprises a sugar alcohol, an alkanolamine, pentaerythritol, or mixtures thereof. In certain embodiments, the nitrogen-based protective agent comprises ammonium hydroxide. In certain embodiments, the aqueous binder composition has an uncured pH of 4.2 to 6.5. In certain embodiments, the non-ionic surfactant comprises an ethoxylated propoxylated polyarylphenol ether. In certain embodiments, the aqueous binder composition is cured at a temperature of from about 450° F. to 480° F.

In certain embodiments, a mineral wool plant substrate comprising mineral wool fibers bound by a binder is provided. The binder is formed from an aqueous binder composition comprising at least 50 wt. % of a polyacrylic acid, a salt of a polyacrylic acid, an anhydride of a polyacrylic acid, or a polyacrylic-acid based resin, based on a total weight of solids in the aqueous binder composition; from about 5 wt. % to about 50 wt. % of a sugar alcohol, based on a total weight of solids in the aqueous binder composition; ammonium hydroxide; and from about 0.05 wt. % to about 0.7 wt. % of an ethoxylated propoxylated polyarylphenol ether.

In certain embodiments, the mineral wool plant substrate is in the form of a plug, a block, or a slab. In certain embodiments, the mineral wool plant substrate exhibits a sink time of less than 25 seconds for a 6 pcf product, a water absorption of greater than 90%, a compressive strength of at least 400 lb/ft², and a puncture resistance of at least 7 lb/ft².

Numerous other aspects, advantages, and/or features of the general inventive concepts will become more readily apparent from the following detailed description of exemplary embodiments and from the accompanying drawings being submitted herewith.

### BRIEF DESCRIPTION OF THE DRAWINGS

The general inventive concepts, as well as illustrative embodiments and advantages thereof, are described below in greater detail, by way of example, with reference to the drawings in which:

FIG. 1 is a perspective view of a fibrous substrate in the form of a cube for promoting plant growth according to one or more embodiments shown and described herein;

FIG. 2 illustrates an exemplary esterification reaction under limited crosslinking due to the formation of carboxylic metal complexes between mineral wool fibers and unprotected carboxylic acid;

FIG. 3 illustrates an exemplary esterification reaction with a partially protected carboxylic acid-based binder;

FIG. 4 illustrates an exemplary method for producing a mineral wool product according to one or more embodiments shown and described herein;

FIG. 5 is a graph showing the water absorption in 5 minutes (in %) for mineral wool products prepared using various formaldehyde-free binder formulations without surfactant according to Example 1 herein;

FIG. 6 is a graph showing the bond strength (in lb/ft²) for mineral wool products prepared using various formaldehyde-free binder formulations without surfactant according to Example 1 herein;

FIG. 7 is a graph showing the bond strength (in lb/ft²) for mineral wool products in accordance with one or more embodiments shown and described herein;

FIG. 8 is a graph showing the sink time (in seconds) for mineral wool products in accordance with one or more embodiments shown and described herein;

FIG. 9 is a graph showing the water absorption in 5 minutes (in %) for mineral wool products in accordance with one or more embodiments shown and described herein;

FIG. 10 is a graph showing the compressive strength at 25% deformation (in lb/ft²) for mineral wool products in accordance with one or more embodiments shown and described herein;

FIG. 11 is a graph showing the puncture resistance (in lb/ft²) for mineral wool products in accordance with one or more embodiments shown and described herein; and

FIG. 12 is a graph showing the surface tension (Y-axis, in N/m) as a function of time (X-axis, in seconds) for mineral wool products in accordance with one or more embodiments shown and described herein.

### DETAILED DESCRIPTION

Unless otherwise defined, all technical and scientific terms used herein have the same meaning as commonly understood by one of ordinary skill in the art to which these exemplary embodiments belong. The terminology used in the description herein is for describing exemplary embodiments only and is not intended to be limiting of the exemplary embodiments. Accordingly, the general inventive concepts are not intended to be limited to the specific embodiments illustrated herein. Although other methods and materials similar or equivalent to those described herein can be used in the practice or testing of the present invention, the preferred methods and materials are described herein.

As used in the specification and the appended claims, the singular forms “a,” “an,” and “the” are intended to include the plural forms as well, unless the context clearly indicates otherwise.

By “substantially free” it is meant that a composition includes less than 1.0 wt. % of the recited component, including no greater than 0.8 wt. %, no greater than 0.6 wt. %, no greater than 0.4 wt. %, no greater than 0.2 wt. %, no greater than 0.1 wt. %, and no greater than 0.05 wt. %. In any of the exemplary embodiments, “substantially free” means that a composition includes no greater than 0.01 wt. % of the recited component.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least, each numerical parameter should be construed in light of the number of significant digits and ordinary rounding approaches.

Unless otherwise indicated, any element, property, feature, or combination of elements, properties, and features, may be used in any embodiment disclosed herein, regardless of whether the element, property, feature, or combination of elements, properties, and features was explicitly disclosed in the embodiment. It will be readily understood that features described in relation to any particular aspect described herein may be applicable to other aspects described herein provided the features are compatible with that aspect. In particular: features described herein in relation to the method may be applicable to the fibrous product and vice versa; features described herein in relation to the method may be applicable to the aqueous binder composition and vice versa; and features described herein in relation to the fibrous product may be applicable to the aqueous binder composition and vice versa.

Every numerical range given throughout this specification and claims will include every narrower numerical range that falls within such broader numerical range, as if such narrower numerical ranges were all expressly written herein.

The present disclosure relates to formaldehyde-free or “no added formaldehyde” aqueous binder compositions for use with inorganic fibers, such as glass or mineral wool fibers. As used herein, the terms “binder composition,” “aqueous binder composition,” “binder formulation,” “binder,” and “binder system’ may be used interchangeably and are synonymous.

The general inventive concepts relate to a fiber-based substrate for supporting the growth of plants in the absence of soil. The use of mineral wool fibers or the like in the substrate avoids problems associated with conventional growth substrates and/or provides advantages and features not previously available with conventional growth substrates.

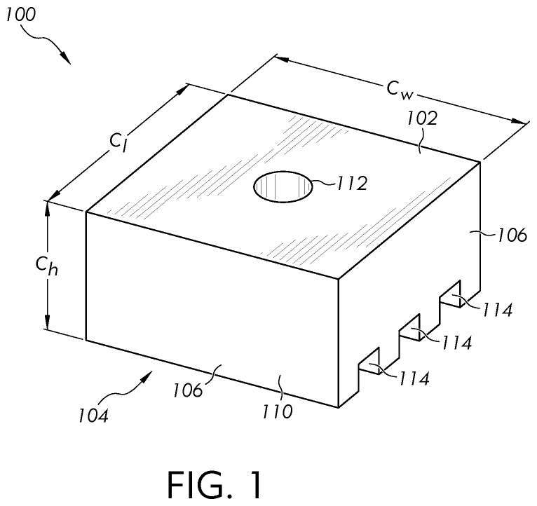

In one exemplary embodiment, a fiber-based substrate in the form of a cube 100 is shown in FIG. 1. The cube 100 has a fixed volume defined by an upper surface 102, a lower surface 104, and four side surfaces 106 situated between the upper surface 102 and the lower surface 104. The cube 100 can have any dimensions suitable for supporting a growth stage of a plant. In some exemplary embodiments, the cube 100 has a width c_{w} in the range of 2 inches to 8 inches; a length cₗ in the range of 2 inches to 8 inches, and a height cₕ in the range of 2 inches to 8 inches. In some exemplary embodiments, c_{w}=cₗ=cₕ. Although various embodiments described herein will be described with reference to the cube 100, it is contemplated that in other embodiments, the fiber-based substrate can take another form, such as a plug (e.g., substantially cylindrical with end surfaces of the cylinder forming the top and bottom surfaces of the growth substrate) or a slab.

Suitable fibers for use in the fibrous products of the present disclosure include, but are not limited to, mineral fibers (e.g., mineral wool, rock wool, stone wool, slag wool, and the like), glass fibers, carbon fibers, ceramic fibers, natural fibers, and synthetic fibers. In certain exemplary embodiments, the plurality of randomly oriented fibers are mineral wool fibers, including, but not limited to mineral wool fibers, rock wool fibers, slag wool fibers, stone wool fibers, or combinations thereof.

The fiber-based substrates may be formed entirely of one type of fiber, or they may be formed of a combination of two or more types of fibers. For example, the fiber-based substrates may be formed of combinations of various types of mineral fibers or various combinations of different inorganic fibers and/or natural fibers depending on the desired application. In certain exemplary embodiments, the fiber-based substrates are formed entirely of mineral wool fibers.

In some exemplary embodiments, the mineral wool fibers are oriented in a horizontal manner to be substantially parallel to one another. In some exemplary embodiments, the mineral wool fibers are oriented in a vertical manner to be substantially parallel to one another. In some exemplary embodiments, the mineral wool fibers are randomly distributed within the body of the cube 100. In some exemplary embodiments, the mineral wool fibers are oriented in a first direction in one region of the cube 100 and in a second direction in another region of the cube 100. The cube 100 has a density in the range of 30 kg/m³ to 150 kg/m³.

In any of the exemplary embodiments, the mineral wool fibers may have an average fiber diameter in the range of 1 μm to 20 μm. In some exemplary embodiments, the mineral wool fibers are formed to have an average fiber diameter in the range of 3 μm to 8 μm. In some exemplary embodiments, the mineral wool fibers are formed to have an average fiber diameter of less than or equal to 5 μm.

In some exemplary embodiments, a length of the mineral wool fibers is in the range of 0.1 inches to 21.0 inches, from 0.1 inches to 15 inches, from 0.1 inches to 10 inches, from 0.1 inches to 5 inches, or from 0.1 inches to 3 inches.

Compared to glass fibers, mineral wool generally has a higher percentage of bi- and tri-valent metal oxides. Table 1 provides the typical glass wool formulation ranges and typical stone (or mineral) wool formulation ranges. Guldberg, Marianne, et al. “The Development of Glass and Stone Wool Compositions with Increased Biosolubility” Regulatory Toxicology and Pharmacology 32, 184-189 (2000). As shown below, glass wool has a total weight percentage of bi- and tri-valent oxides (CaO/MgO/Al₂O₃/FeO) that is no greater than 25 wt. %. In contrast, mineral or stone wool comprise a minimum of 25 wt. % bi- and tri-valent metal oxides, or, in some instances, greater than 30 wt. % bi- and tri-valent metal oxides, and in some instances at least 50 wt. % bi- and tri-valent metal oxides. Such metal oxides, particularly aluminum, have a strong tendency to complex with acidic functionalities, such as carboxylic acids, which inhibits binder wetting on the fibers and prevents sufficient esterification and crosslinking. Accordingly, traditional acidic formaldehyde-free binders show decreased performance with mineral wool fibers.

TABLE 1
Traditional Insulation Wool Compositions (in Weight %)

| | Glass wool traditional: | Stone wool traditional: |
|---|---|---|
| | Typical ranges | Typical ranges |
| SiO₂ | 60-70 | 43-50 |
| Al₂O₃ | 3-7 | 6-15 |
| TiO₂ | <0.1 | 0.5-3.5 |
| FeO | <0.5 | 3-8 |
| CaO | 5-13 | 10-25 |
| MgO | 0-5 | 6-16 |
| Na₂O | 13-18 | 1-3.5 |
| K₂O | 0-2.5 | 0.5-2 |
| B₂O₃ | 3-7 | <1 |
| P₂O₅ | <0.1 | <1 |

Within the cube 100, the mineral wool fibers are held together by a binder. Upon curing, the binder “locks” the fibers together to form a matrix capable of mechanically supporting the plant during at least a portion of its growth stage.

In any of the exemplary embodiments, the binder composition may include an acidic crosslinking agent suitable for crosslinking with a polyol component via an esterification reaction. The crosslinking agent may have a number-average molecular weight greater than 90 Daltons, such as from about 90 Daltons to about 10,000 Daltons, or from about 190 Daltons to about 5,000 Daltons. In any of the exemplary embodiments, the crosslinking agent may have a number-average molecular weight of about 2,000 Daltons to 5,000 Daltons, or about 4,000 Daltons.

Non-limiting examples of suitable crosslinking agents include materials having one or more carboxylic acid groups (—COOH), such as monomeric and polymeric polycarboxylic acids, including salts or anhydrides thereof, and mixtures thereof. In any of the exemplary embodiments, the polycarboxylic acid may be a polymeric polycarboxylic acid, such as a homopolymer or copolymer of acrylic acid. The polymeric polycarboxylic acid may comprise polyacrylic acid (including salts or anhydrides thereof) and polyacrylic acid-based resins such as QR-1629S and Acumer 9932, both commercially available from The Dow Chemical Company, polyacrylic acid compositions commercially from CH Polymer, and polyacrylic acid compositions commercially available from Coatex. Acumer 9932 is a polyacrylic acid/sodium hypophosphite resin having a molecular weight of about 4000 and a sodium hypophosphite content of 6-7% by weight, based on the total weight of the polyacrylic acid/sodium hypophosphite resin. QR-1629S is a polyacrylic acid/glycerin resin composition.

In any of the exemplary embodiments disclosed herein, the crosslinking agent may be present in the binder composition in at least 50 wt. %, based on the total solids content of the binder composition, including, without limitation at least 55 wt. %, at least 60 wt. %, at least 63 wt. %, at least 65 wt. %, at least 68 wt. %, at least 70 wt. %, at least 71 wt. %, at least 73 wt. %, and at least 75.0 wt. %. In any of the exemplary embodiments, the crosslinking agent may be present in the binder composition in an amount from 50% to 85% by weight, based on the total solids content of the binder composition, including without limitation 60% to 82% by weight, 65% to 80% by weight, and 68% to 78% by weight, including all endpoints and sub-combinations therebetween.

Optionally, all or a percentage of the acid functionality in the polycarboxylic acid may be temporarily blocked with the use of a protective agent, which temporarily blocks the acid functionality from complexing with the mineral wool fibers, and is subsequently removed by heating the binder composition to a temperature of at least 150° C., freeing the acid functionalities to crosslink with the polyol component and complete the esterification process, during the curing process. In any of the exemplary embodiments, 10% to 100% of the carboxylic acid functional groups may be temporarily blocked by the protective agent, including between about 25% to about 99%, about 30% to about 90%, and about 40% to 85%, including all subranges and combinations of ranges therebetween. In any of the exemplary embodiments, a minimum of 40% of the acid functional groups may be temporarily blocked by the protective agent.

The protective agent may be capable of reversibly bonding to the carboxylic acid groups of the crosslinking agent. In any of the exemplary embodiments, the protective agent comprises any compound comprising molecules capable of forming at least one reversible ionic bond with a single acid functional group. In any of the exemplary embodiments disclosed herein, the protective agent may comprise a nitrogen-based protective agent, such as an ammonium-based protective agent; an amine-based protective agent; or mixtures thereof. An exemplary ammonium based protective agent includes ammonium hydroxide. Exemplary amine-based protective agents include alkylamines and diamines, such as, for example ethyleneimine, ethylenediamine, hexamethylenediamine; alkanolamines, such as: ethanolamine, diethanolamine, triethanolamine; ethylenediamine-N,N′-disuccinic acid (EDDS), ethylenediaminetetraacetic acid (EDTA), and the like, or mixtures thereof. In addition, it has been surprisingly discovered that the alkanolamine can be used as both a protecting agent and as a participant in the crosslinking reaction to form ester in the cured binder. Thus, the alkanolamine has a dual-functionality of protective agent and polyol for crosslinking with the polycarboxylic acid via esterification.

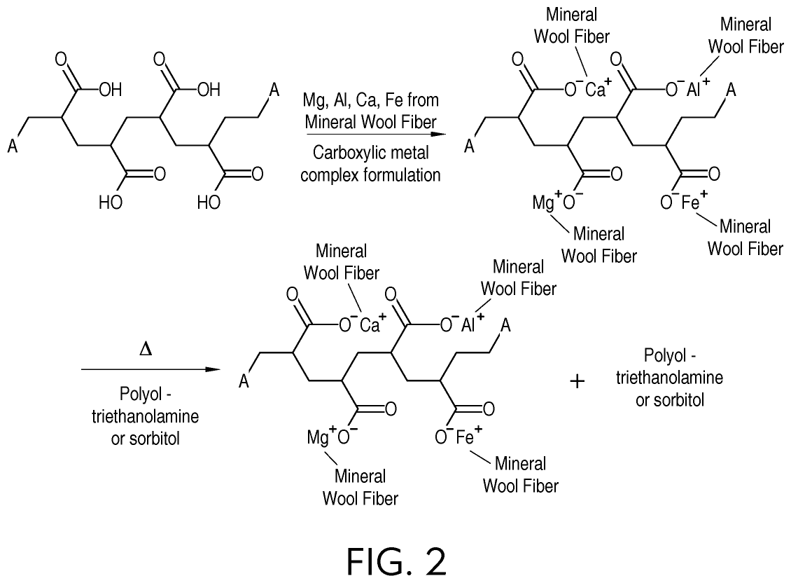

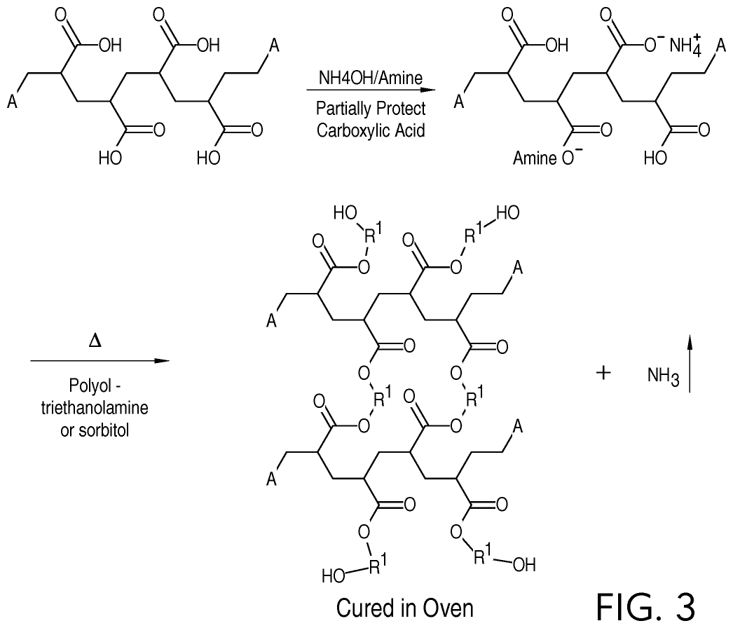

As illustrated in FIG. 2, if left unprotected, the carboxylic acid groups in the polycarboxylic acid component will form a carboxylic-metal complex with the metal ions (Mg²⁺, Al³⁺, Ca²⁺, Fe³⁺, Fe²⁺) from the mineral wool fibers. Under such circumstances, as the binder composition is cured, the polyol will have very limited availability to crosslink with the carboxylic acid groups, leading to weak binder performance. In contrast, FIG. 3 illustrates the pre-reaction of the polycarboxylic acid with a nitrogen-based protective agent, such as ammonium hydroxide or an amine. Such a pre-reaction temporarily blocks the acid functional groups from permanently reacting with the metal ions. As the binder is cured, ammonia is released, freeing the acid functional groups to react with the polyol via esterification.

The protective agent functions differently than a conventional pH adjuster. A protective agent, as defined herein, only temporarily and reversibly blocks the acid functional groups in the polymeric polycarboxylic acid component. In contrast, conventional pH adjusters, such as sodium hydroxide, permanently terminate an acid functional group, which prevents crosslinking between the acid and hydroxyl groups due to the blocked acid functional groups. Thus, the inclusion of traditional pH adjusters, such as sodium hydroxide, does not provide the desired effect of temporarily blocking the acid functional groups, while later freeing up those functional groups during to cure to permit crosslinking via esterification. Accordingly, in any of the exemplary embodiments disclosed herein, the binder composition may be free or substantially free of conventional pH adjusters, such as, for example, sodium hydroxide and potassium hydroxide. Such conventional pH adjusters for high temperature applications will permanently bond with the carboxylic acid groups and will not release the carboxylic acid functionality to allow for crosslinking esterification.

Moreover, along with providing a temporary blocking function, the protective agent also increases the pH of the binder composition to provide compatibility with the pH of the mineral wool fiber. If the pH of the binder composition is significantly lower than the pH of the fiber, the binder composition can damage the mineral fiber, which changes the composition and weakens the fiber. The function of the binder composition is to adhere the fibers together and should not react with the fiber itself.

The pH of the binder composition in an un-cured state may be adjusted depending on the intended application, to facilitate the compatibility of the ingredients of the binder composition, or to function with various types of fibers. In any of the exemplary embodiments disclosed herein, when in an un-cured state, the pH of the binder composition has a pH of at least about 4. In such exemplary embodiments, the pH of the binder composition, when in an un-cured state, may be about 4.0-7.0, including about 4.2-6.8, and about 4.5-6.5. After cure, the pH of the binder composition may rise to at least a pH of 6.5 and up to pH of 8.5. In any of the exemplary embodiments disclosed herein, the cured pH of the binder composition is between 7.2 and 7.8.

The protective agent may be present in the binder composition in an amount from 1.25 wt. % to 50.0 wt. %, based on the total solids in the binder composition, including without limitation, amounts from 2.50 wt. % to 25.0 wt. %, or from 3.0 wt. % to 15.5 wt. %. In any of the exemplary embodiments disclosed herein, the protective agent is present in the binder composition in at least 3.5 wt. %, including at least 4.0 wt. %, at least 5.0 wt. %, at least 6.0 wt. %, and at least 8.0 wt. %. In any of the exemplary embodiments, the protective agent may be used in an amount sufficient to block at least 40% of the acid functional groups of the polycarboxylic acid.

In any of the exemplary embodiments, the binder composition includes a ratio of carboxylic acid groups to amine groups ranges from about 6:1 to about 1:1, or from about 4:1 to about 1.5:1.

In any of the exemplary embodiments, the binder composition further includes at least one polyol having two or more hydroxyl groups (also referred to herein as a polyhydroxy compound). In any of the exemplary embodiments, the polyol comprises one or more of monomeric or polymeric polyhydroxy compounds.

Exemplary polyols include pentaerythritol, alkanolamines, mixtures thereof, or derivatives thereof. In any of the exemplary embodiments, the alkanolamine may comprise triethanolamine, or derivatives thereof. Accordingly, in some exemplary embodiments, the polyol comprises one or more of pentaerythritol, triethanolamine, derivatives thereof, or mixtures thereof.

In exemplary embodiments, the polyol may comprise one or more sugar alcohols. Sugar alcohol is understood to mean compounds obtained when the aldo or keto groups of a sugar are reduced (e.g., by hydrogenation) to the corresponding hydroxy groups. The starting sugar might be chosen from monosaccharides, oligosaccharides, and polysaccharides, and mixtures of those products, such as syrups, molasses, and starch hydrolyzates. The starting sugar also could be a dehydrated form of a sugar. Although sugar alcohols closely resemble the corresponding starting sugars, they are not sugars. Thus, for instance, sugar alcohols have no reducing ability, and cannot participate in the Maillard reaction typical of reducing sugars. In any of the exemplary embodiments, the sugar alcohol includes any of glycerol, erythritol, arabitol, xylitol, sorbitol, maltitol, mannitol, iditol, isomaltitol, lactitol, cellobitol, palatinitol, maltotritol, syrups thereof, and mixtures thereof. In various exemplary embodiments, the sugar alcohol is selected from glycerol, sorbitol, xylitol, and mixtures thereof. In any of the exemplary embodiments, the polyol may be a dimeric or oligomeric condensation product of a sugar alcohol. In any of the exemplary embodiments, the condensation product of a sugar alcohol may be isosorbide. In any of the exemplary embodiments, the sugar alcohol may be a diol or glycol.

In any of the exemplary embodiments, the binder composition may be free of reducing sugars. A reducing sugar is a type of carbohydrate or sugar that includes a free aldehyde or ketone group and can donate electrons to another molecule. As the binder composition is free of reducing sugars, it is unable to participate in a Maillard reaction, which is a process that occurs when a reducing sugar reacts with an amine. The Maillard reaction results in a binder composition with a brown color, which is undesirable for the subject binder composition.

In any of the exemplary embodiments, the polyol may include at least one carbohydrate that is natural in origin and derived from renewable resources. For instance, the carbohydrate may be derived from plant sources such as legumes, maize, corn, waxy corn, sugar cane, milo, white milo, potatoes, sweet potatoes, tapioca, rice, waxy rice, peas, sago, wheat, oat, barley, rye, amaranth, and/or cassava, as well as other plants that have a high starch content. The carbohydrate may also be derived from crude starch-containing products derived from plants that contain residues of proteins, polypeptides, lipids, and low molecular weight carbohydrates. The carbohydrate may be selected from monosaccharides (e.g., xylose, glucose, and fructose), disaccharides (e.g., sucrose, maltose, and lactose), oligosaccharides (e.g., glucose syrup and fructose syrup), and polysaccharides and water-soluble polysaccharides (e.g., pectin, dextrin, maltodextrin, starch, modified starch, and mixtures thereof).

The carbohydrate may be a carbohydrate polymer having a number average molecular weight from about 1,000 to about 8,000. Additionally, the carbohydrate polymer may have a dextrose equivalent (DE) number from 2 to 20, from 7 to 11, or from 9 to 14. In at least one exemplary embodiment, the carbohydrate is a water-soluble polysaccharide such as dextrin or maltodextrin.

The polyol may be present in the binder composition in an amount up to about 50% by weight total solids, including without limitation, up to about 40%, about 35%, about 30%, about 28%, and about 25% by weight total solids. In any of the exemplary embodiments, the polyol may be present in the binder composition in an amount from 5.0% to about 50% by weight total solids, including without limitation 10% to 45%, 15% to 40%, 18% to 38%, 20% to 35%, 22% to 32%, 20% to 50%, and 17% to 27%, by weight total solids, including all endpoints and sub-combinations therebetween. In any of the exemplary embodiments, the polyol may be present in an amount to provide a ratio of carboxylic acid groups to hydroxyl groups from 10:1 to 0.2:1, or from 3:1 to 0.5:1.

In various embodiments, the binder composition may include a surfactant. One or more surfactants may be included in the binder composition to assist in binder atomization, wetting, and interfacial adhesion.

The surfactant is not particularly limited, and includes surfactants such as, but not limited to, ionic surfactants (e.g., sulfate, sulfonate, phosphate, and carboxylate); sulfates (e.g., alkyl sulfates, ammonium lauryl sulfate, sodium lauryl sulfate (SDS), alkyl ether sulfates, sodium laureth sulfate, and sodium myreth sulfate); amphoteric surfactants (e.g., alkylbetaines such as lauryl-betaine); sulfonates (e.g., dioctyl sodium sulfosuccinate, perfluorooctanesulfonate, perfluorobutanesulfonate, and alkyl benzene sulfonates); phosphates (e.g., alkyl aryl ether phosphate and alkyl ether phosphate); carboxylates (e.g., alkyl carboxylates, fatty acid salts (soaps), sodium stearate, sodium lauroyl sarcosinate, carboxylate fluoro surfactants, perfluoronanoate, and perfluorooctanoate); cationic (e.g., alkylamine salts such as laurylamine acetate); pH dependent surfactants (primary, secondary or tertiary amines); permanently charged quaternary ammonium cations (e.g., alkyltrimethylammonium salts, cetyl trimethylammonium bromide, cetyl trimethylammonium chloride, cetylpyridinium chloride, and benzethonium chloride); and zwitterionic surfactants, quaternary ammonium salts (e.g., lauryl trimethyl ammonium chloride and alkyl benzyl dimethylammonium chloride), polyoxyethylenealkylamines, and mixtures thereof.

Suitable nonionic surfactants that can be used in conjunction with the binder composition include polyethers (e.g., ethylene oxide and propylene oxide condensates, which include straight and branched chain alkyl and alkaryl polyethylene glycol and polypropylene glycol ethers and thioethers); alkylphenoxypoly(ethyleneoxy)ethanols having alkyl groups containing from about 7 to about 18 carbon atoms and having from about 4 to about 240 ethyleneoxy units (e.g., heptylphenoxypoly(ethyleneoxy) ethanols, and nonylphenoxypoly(ethyleneoxy) ethanols); polyoxyalkylene derivatives of hexitol including sorbitans, sorbides, mannitans, and mannides; partial long-chain fatty acids esters (e.g., polyoxyalkylene derivatives of sorbitan monolaurate, sorbitan monopalmitate, sorbitan monostearate, sorbitan tristearate, sorbitan monooleate, and sorbitan trioleate); condensates of ethylene oxide with a hydrophobic base, the base being formed by condensing propylene oxide with propylene glycol; sulfur containing condensates (e.g., those condensates prepared by condensing ethylene oxide with higher alkyl mercaptans, such as nonyl, dodecyl, or tetradecyl mercaptan, or with alkylthiophenols where the alkyl group contains from about 6 to about 15 carbon atoms); ethylene oxide derivatives of long-chain carboxylic acids (e.g., lauric, myristic, palmitic, and oleic acids, such as tall oil fatty acids); ethylene oxide derivatives of long-chain alcohols (e.g., octyl, decyl, lauryl, or cetyl alcohols); and ethylene oxide/propylene oxide copolymers. In one particular embodiment, the binder includes a nonionic surfactant in the form of an ethoxylated propoxylated polyarylphenol ether, block copolymer.

In any of the exemplary embodiments, the surfactants may include STEP-FLOW® 1500, an ethoxylated propoxylated polyarylphenol ether, block copolymer commercially available from Stepan. In particular, the STEP-FLOW® 1500 was surprisingly found to provide the desired hydrophilicity, which increases the ability of the fiber-based product to absorb water, while also having a thermal stability that enables it to survive the thermal processing of the fiber-based product. Moreover, the inclusion of the STEP-FLOW® 1500 in the fiber-based products demonstrated improvements in bond strength when compared to an otherwise identical fiber-based product not including surfactant, and lowered the energy to cure the binder. For example, when as little as 1.0% of the STEP-FLOW® 1500 by weight of the glass was added, an oven temperature of 460° F. was effective to achieve the same curing levels that an otherwise identical fiber-based product not including surfactant achieved at 520° F. Surfactants may additionally or alternatively include one or more of Dynol 607, which is a 2,5,8,11-tetramethyl-6-dodecyne-5,8-diol, SURFONYL® 420, SURFONYL® 440, and SURFONYL® 465, which are ethoxylated 2,4,7,9-tetramethyl-5-decyn-4,7-diol surfactants (commercially available from Evonik Corporation (Allentown, Pa.)), Stanfax (a sodium lauryl sulfate), Surfynol 465 (an ethoxylated 2,4,7,9-tetramethyl 5 decyn-4,7-diol), Triton™ GR-PG70 (1,4-bis(2-ethylhexyl) sodium sulfosuccinate), and Triton™ CF-10 (poly(oxy-1,2-ethanediyl), alpha-(phenylmethyl)-omega-(1,1,3,3-tetramethylbutyl)phenoxy).

The surfactant may be present in the binder composition in an amount from 0 to about 10% by weight, from about 0.01% to about 5.0% by weight, from about 0.05% to about 2.5% by weight, from about 0.05% to about 0.7% by weight, or from about 0.1% to about 0.7% by weight, based on the total solids content in the binder composition.

Optionally, the binder composition may include an esterification catalyst, also known as a cure accelerator. The catalyst may include inorganic salts, Lewis acids (i.e., aluminum chloride or boron trifluoride), Bronsted acids (i.e., sulfuric acid, p-toluenesulfonic acid and boric acid) organometallic complexes (i.e., lithium carboxylates, sodium carboxylates), and/or Lewis bases (i.e., polyethyleneimine, diethylamine, or triethylamine). Additionally, the catalyst may include an alkali metal salt of a phosphorous-containing organic acid; in particular, alkali metal salts of phosphorus acid, hypophosphorus acid, or polyphosphoric. Examples of such phosphorus catalysts include, but are not limited to, sodium hypophosphite, sodium phosphate, potassium phosphate, disodium pyrophosphate, tetrasodium pyrophosphate, sodium tripolyphosphate, sodium hexametaphosphate, potassium phosphate, potassium tripolyphosphate, sodium trimetaphosphate, sodium tetrametaphosphate, and mixtures thereof. In addition, the catalyst or cure accelerator may be a fluoroborate compound such as fluoroboric acid, sodium tetrafluoroborate, potassium tetrafluoroborate, calcium tetrafluoroborate, magnesium tetrafluoroborate, zinc tetrafluoroborate, ammonium tetrafluoroborate, and mixtures thereof. Further, the catalyst may be a mixture of phosphorus and fluoroborate compounds. Other sodium salts such as, sodium sulfate, sodium nitrate, sodium carbonate may also or alternatively be used as the catalyst.

The catalyst may be present in the binder composition in an amount from about 0% to about 10% by weight of the total solids in the binder composition, including without limitation, amounts from about 0 to about 5% by weight, or from about 0.5% to about 4.5% by weight, or from about 1.0% to about 4.0% by weight, or from about 1.15% to about 3.8% by weight.

Optionally, the binder composition may contain at least one coupling agent. In at least one exemplary embodiment, the coupling agent is a silane coupling agent. The coupling agent(s) may be present in the binder composition in an amount from about 0.01% to about 5% by weight of the total solids in the binder composition, from about 0.01% to about 2.5% by weight, from about 0.05% to about 1.5% by weight, or from about 0.1% to about 1.0% by weight.

Non-limiting examples of silane coupling agents that may be used in the binder composition may be characterized by the functional groups alkyl, aryl, amino, epoxy, vinyl, methacryloxy, ureido, isocyanato, and mercapto. In exemplary embodiments, the silane coupling agent(s) include silanes containing one or more nitrogen atoms that have one or more functional groups such as amine (primary, secondary, tertiary, and quaternary), amino, imino, amido, imido, ureido, or isocyanato. Specific, non-limiting examples of suitable silane coupling agents include, but are not limited to, aminosilanes (e.g., triethoxyaminopropylsilane; 3-aminopropyl-triethoxysilane and 3-aminopropyl-trihydroxysilane), epoxy trialkoxysilanes (e.g., 3-glycidoxypropyltrimethoxysilane and 3-glycidoxypropyltriethoxysilane), methyacryl trialkoxysilanes (e.g., 3-methacryloxypropyltrimethoxy silane and 3 methacryloxypropyltriethoxysilane) hydrocarbon trialkoxysilanes, amino trihydroxysilanes, epoxy trihydroxysilanes, methacryl trihydroxy silanes, and/or hydrocarbon trihydroxysilanes. In one or more exemplary embodiment, the silane is an aminosilane, such as γ-aminopropyltriethoxy silane.

Optionally, the binder composition may include one or more processing aids. The processing aid is not particularly limiting so long as the processing aid functions to facilitate the processing of the fibers formation and orientation. The processing aid can be used to improve binder application distribution uniformity, to reduce binder viscosity, to increase ramp height after forming, to improve the vertical weight distribution uniformity, and/or to accelerate binder de-watering in both forming and oven curing process. The processing aid may be present in the binder composition in an amount from 0 to about 15% by weight, from about 0.1% to about 10.0% by weight, or from about 0.3% to about 5.0% by weight, or from about 0.5% to 2.0% by weight, based on the total solids content in the binder composition. In any of the exemplary embodiments, the aqueous binder composition may be substantially or completely free of any processing aids.

Examples of processing aids include defoaming agents, such as, emulsions and/or dispersions of mineral, paraffin, or vegetable oils; silicone, dispersions of polydimethylsiloxane (PDMS) fluids, and silica which has been hydrophobized with polydimethylsiloxane or other materials. Further processing aids may include particles made of amide waxes such as ethylenebis-stearamide (EBS) or hydrophobized silica.

Further processing aids may comprise viscosity modifiers including, for example, glycerol, 1,2,4-butanetriol, 1,4-butanediol, 1,2-propanediol, 1,3-propanediol, poly(ethylene glycol), and combinations thereof.

Optionally, the binder composition may contain a dust suppressing agent to reduce or eliminate the presence of inorganic and/or organic particles which may have adverse impact in the subsequent fabrication and installation of the insulation materials. The dust suppressing agent can be any conventional mineral oil, mineral oil emulsion, natural or synthetic oil, bio-based oil, or lubricant, such as, but not limited to, silicone and silicone emulsions, polyethylene glycol, as well as any petroleum or non-petroleum oil with a high flash point to minimize the evaporation of the oil inside the oven.

In any of the exemplary embodiments, the binder composition may include up to about 10 wt. % of a dust suppressing agent, including up to about 8 wt. %, or up to about 6 wt. %. In any of the exemplary embodiments, the binder composition may include between 0 wt. % and 10 wt. % of a dust suppressing agent, including about 1.0 wt. % to about 7.0 wt. %, or about 1.5 wt. % to about 6.5 wt. %, or about 2.0 wt. % to about 6.0 wt. %, or about 2.5 wt. % to 5.8 wt. %.

The binder composition further includes water to dissolve or disperse the active solids for application onto the reinforcement fibers. Water may be added in an amount sufficient to dilute the binder composition to a viscosity that is suitable for its application to the reinforcement fibers and to achieve a desired solids content on the fibers. It has been discovered that the present binder composition may contain a lower solids content than traditional phenol-urea formaldehyde or carbohydrate-based binder compositions. In particular, the binder composition may comprise 3% to 35% by weight of binder solids, including without limitation, 10% to 30%, 12% to 20%, and 15% to 19% by weight of binder solids.

The binder content on a product may be measured as loss on ignition (LOI). In any of the exemplary embodiments, the LOI on the mineral wool fibers may be 0.1% to 50%, including without limitation, 0.15% to 10%, 0.2% to 10%, and 0.3% to 5%. In some embodiments, the LOI on the mineral wool fibers may be from 1.0% to 5.0%, from 1.5% to 4.5%, from 2.0% to 4.0%, from 2.5% to 3.0%. As known in the art, this ignition loss can be considered to be the binder content/weight.

In any of the exemplary embodiments, the binder composition may also include one or more additives, such as an extender, a crosslinking density enhancer, a deodorant, an antioxidant, a dust suppressing agent, a biocide, a moisture resistant agent, or combinations thereof. Optionally, the binder may comprise, without limitation, dyes, pigments, additional fillers, colorants, UV stabilizers, thermal stabilizers, anti-foaming agents, emulsifiers, preservatives (e.g., sodium benzoate), corrosion inhibitors, and mixtures thereof. Other additives may be added to the binder composition for the improvement of process and product performance. Such additives include lubricants, wetting agents, antistatic agents, and/or water repellent agents. Additives may be present in the binder composition from trace amounts (such as <about 0.1% by weight the binder composition) up to about 10% by weight of the total solids in the binder composition.

In any of the exemplary embodiments, the binder composition may be free or substantially free of a monomeric carboxylic acid component. Exemplary monomeric polycarboxylic acid components include aconitic acid, adipic acid, azelaic acid, butane tetra carboxylic acid dihydrate, butane tricarboxylic acid, chlorendic anhydride, citraconic acid, citric acid, dicyclopentadiene-maleic acid adducts, diethylenetriamine pentacetic acid pentasodium salt, adducts of dipentene and maleic anhydride, endomethylenehexachlorophthalic anhydride, fully maleated rosin, maleated tall oil fatty acids, fumaric acid, glutaric acid, isophthalic acid, itaconic acid, maleated rosin-oxidize unsaturation with potassium peroxide to alcohol then carboxylic acid, malic acid, maleic anhydride, mesaconic acid, oxalic acid, phthalic anhydride, polylactic acid, sebacic acid, succinic acid, tartaric acid, terephthalic acid, tetrabromophthalic anhydride, tetrachlorophthalic anhydride, tetrahydrophthalic anhydride, trimellitic anhydride, and trimesic acid.

In any of the exemplary embodiments, the binder composition includes at least one crosslinking agent, a protective agent, a polyol, a nonionic surfactant, and has a pH of at least 4.

TABLE 2

| | Exemplary Range 1 | Exemplary Range 2 |
|---|---|---|
| | (% By Weight of Total | (% By Weight of Total |
| Component | Solids) | Solids) |
| Crosslinking Agent | 50-80 | 53-75 |
| Nitrogen-based | 1.25-40.0 | 2.0-25.0 |
| Protective Agent | | |
| Polyol | 10-40* | 15-30 |
| Nonionic surfactant | 0.05-0.7 | 0.05-0.7 |
| COOH/Nitrogen | 4:1 | 1.5:1 |
| Ratio | | |

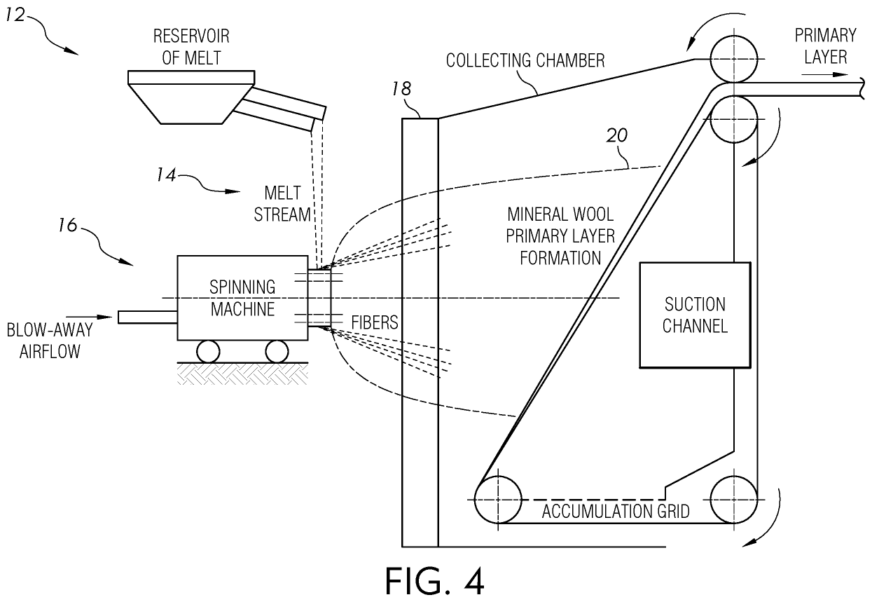

An exemplary method for producing a mineral wool product according to various embodiments is outlined in FIG. 4. A melt of raw mineral materials is prepared in a reservoir 12 and a melt stream 14 is descended into a spinning machine 16 (such as a centrifugal spinner), where the melt is fiberized and blown into a collection chamber 18, forming a mineral wool web on a collection belt 20. The binder composition including the surfactant may be applied to the mineral wool fibers before collection on the collection belt, as the fibers are being collected, or after the formation of the mineral wool web. The binder composition may be applied to the mineral wool fibers by known means, such as, for example, by spraying. Although not shown in FIG. 4, in some embodiments, the binder-coated mineral wool web may be passed through a crimper to change the orientation of the fibers. The binder-coated mineral wool web is then heated in a conventional curing oven to cure the binder-coated mineral wool web, forming a mineral wool product. The mineral wool web may be subjected to compression to obtain a desired final product thickness.

Curing may be carried out in a curing oven at conventional temperatures, such as, for example from about 200° C. to about 600° C., such as from about 225° C. to about 550° C., and from about 400° C. to about 525° C. In particular embodiments, curing is carried out at a temperature of from about 450° F. to about 480° F. and is effective to bind the mineral wool fibers.

Returning to FIG. 1, either during or after formation of the cube 100, one or more holes 112 are formed in the upper surface 102 of the cube 100 and one or more grooves 114 or other channels are formed in the lower surface 104 of the cube 100. For example, the holes 112 and the grooves 114 can be formed by removing (e.g., cutting) material from the cube 100. In some exemplary embodiments, the cube 100 includes a plurality of the holes 112. In some exemplary embodiments, a first hole has a different size than a second hole. Each of the holes 112 is shaped and sized to receive a plug containing a seed that may have already started the growth process. The cube 100 is sized to allow for the continued soilless growth of the plant(s).

Water and nutrients can be delivered to the cube 100 by applying (e.g., dripping) a source of feed water onto the upper surface 102 of the cube 100 or by adding water to a supporting tray in which the cube 100 is placed. This nutrient-containing feed water propagates through the cube 100 in such a manner that it can be absorbed by the root system of the plant(s). For example, when water is added to the supporting tray, the water moves into and throughout the cube 100 through capillary action. The excess feed water eventually reaches the lower surface 104 of the cube 100 where the grooves 114 facilitate drainage thereof.

After a plant reaches a certain growth threshold, it is separated from the cube 100 with at least a portion of its root system remaining in the cube 100.

In some exemplary embodiments, a jacket 110 or other wrapping material or container surrounds at least a portion of the cube 100, such as the side surfaces 106. The jacket 110 can contribute to the strength (i.e., the mechanical support) of the cube 100 and/or provide other benefits, such as retaining water within the cube 100. In some exemplary embodiments, the jacket 110 is made of a rigid or semi-rigid material that is readily compostable. For example, a thick paper or cardboard housing could be used.

In some exemplary embodiments, the jacket 110 is a sheet or wrapping material that can dissolve over time, such as a degradable polymer-based (e.g., PVOH) film. In this case, the jacket 110 is formed to maintain its strength during a growth period associated with the plant and/or the service life of the cube 100 (e.g., about 3 months) and then to break down thereafter during a subsequent period of time (e.g., about 3 months to about 6 months). Different plants have different growing periods. In some exemplary embodiments, the growth period associated with the plant is in the range of 1 week to 19 months. In some exemplary embodiments, the growth period associated with the plant is in the range of 8 to 15 days, from 2 months to 19 months, or from 3 months to 4 months. In some exemplary embodiments, the growth period associated with the plant is in the range of 14 months to 18 months. The service life of the cube 100 is generally engineered to correspond to (if not exceed) the growth period of the particular plant to be cultivated therein.

The fiber-based substrate products produced in accordance with the various embodiments described herein demonstrate comparable or improved bond strength, compressive strength, and puncture resistance as compared to competitive products including alternative binder compositions. Bond strength has been found to correlate to the processability of the boards. In particular, boards with low bond strength tend to fuzz during the cutting, stick to the cutting tools and result in fibers being left instead of leaving a clean cylindrical hole when a hole is cut into the middle of the fiber-based product. Compressive strength is important for enabling the fiber-based substrate product to withstand handling during use without significant damage. For example, automated seeding and selection can both involve the use of machinery which can subject the growth substrate to significant pressures and forces, making compressive strength an important mechanical property of the fiber-based product. Additionally, compression strength has been found to affect the water holding capability of the final product.

Moreover, to optimize plant growth, growers typically preset rooms with different lighting, temperature, humidity and nutrient solution conditions. In order to provide these conditions to the plant, growers grab each grow media with the grown plant on it one by one and move it to a different room. The puncture testing can mimic finger puncture in the product. Puncture can break the fibers and consequently the roots growing on them, which can affect plant health.

The bond strength was measured by gluing a 6″×6″ sample from side to side to two 6″×7″ wood boards using hot melt glue. The sample is then placed in the Instron equipped with a 1 kN load cell, and pulled in opposite directions. The results reported are the amount of lb/ft² required to break the bonds, as evidenced by sample breakage in the middle. In various embodiments, the bond strength of the fiber-based substrate products is greater than about 150 lb/ft². For example, the bond strength may be from about 150 lb/ft² to about 250 lb/ft², from about 150 lb/ft² to about 225 lb/ft², from about 160 lb/ft² to about 225 lb/ft², from about 170 lb/ft² to about 225 lb/ft², or from about 170 lb/ft² to about 200 lb/ft².

The compressive strength was measured and tested on a sample using a standard ASTM C165 test method. The fiber-based substrate products formed in accordance with the various embodiments described herein demonstrate a compressive strength of at least 100 lb/ft², including at least 200 lb/ft², at least 300 lb/ft², at least 400 lb/ft², at least 500 lb/ft², or at least 600 lb/ft².

The puncture resistance was measured and tested on a sample using a double column Instron with a 10 KN load cell. A ½ inch diameter puncture fixture is placed in the Instron and punctures the samples one at time at each side. The puncture fixture travels 1 inch deep in the material. The reported value is the amount of lb/ft² required to break/puncture the fibers. The fiber-based substrate products formed in accordance with the various embodiments described herein demonstrate a puncture resistance of at least 2.5 lb/ft², including at least 3 lb/ft², at least 4 lb/ft², at least 5 lb/ft², at least 6 lb/ft², or at least 7 lb/ft².

In addition, fiber-based substrate products formed in accordance with the various embodiments described herein may demonstrate an average sink time of less than or equal to 30 seconds for a 6 pcf board. Sink time is tested by measuring in triplicate the amount of time required to sink a 4 inch×4 inch×4 inch sample in water at room temperature, a 6 inch×6 inch×6 inch sample in water at room temperature, or a 2.5 inch×4 inch×4 inch sample in water at room temperature and is a measure of the speed with which the fiber-based substrate product absorbs water, and reported values are the average for the sample tested in triplicate. For example, the mineral wool growth media products have a sink time of less than or equal to 30 seconds, including less than or equal to 29 seconds, less than or equal to 28 seconds, less than or equal to 27 seconds, less than or equal to 26 seconds, less than or equal to 25 seconds, less than or equal to 24 seconds, or less than or equal to 23 seconds for a 6 pcf board. In some exemplary embodiments, the mineral wool growth media products have a sink time of from about 5 seconds to about 30 seconds, from about 6 seconds to about 28 seconds, from about 7 seconds to about 26 seconds, from about 8 seconds to about 24 seconds, or from about 8 seconds to about 23 seconds, including any and all ranges and subranges therein.

Moreover, the fiber-based substrate products formed in accordance with the various embodiments described herein may demonstrate a water holding capability of at least 50%, at least 55%, at least 60%, at least 65%, at least 70%, at least 75%, at least 80%, at least 85%, at least 90%, or at least 95% of water volume when measured using the Free Drainage test method. For this test, the product is saturated (left to sink until is fully submerged) and then is left to drain on a grid without applying any mechanical stressor that can affect the drainage. The values are calculated by weight.

The free drainage and slab drainage using the following equation:

$$\\ Vol \% water = \frac{( {w}_{f} - {w}_{i} )}{( l * w * t ) - {v}_{c}}$$

where w_{f} is the final weight after drainage of specimen in g, wᵢ is the dry weight of specimen in g, l is the length of specimen in cm, w is the width of specimen in cm, t is the thickness of specimen in cm, and v_{c} is volume of cutouts (if finished product) in cm³.

### EXAMPLES

Having generally described this invention, a further understanding can be obtained by reference to certain specific examples illustrated below which are provided for purposes of illustration only and are not intended to be all inclusive or limiting unless otherwise specified.

### Example 1

Six different binder compositions were applied to mineral wool fibers via a typical mineral wool production line with a throughput of 4.5 tons/hour. Each of the binder compositions was formaldehyde free, but none of these binder compositions included a surfactant. Each of the binder compositions included polyacrylic acid and sorbitol and included an amount of ammonium hydroxide to bring the pH to 5. Each of the binder compositions (Binder A-Binder F) are listed below in Table 3:

TABLE 3

| | Polyacrylic Acid | Sorbitol | Citric Acid | Glycerol |
|---|---|---|---|---|
| Binder A | 70 | 30 | 0 | 0 |
| Binder B | 70 | 30 | 0 | 10 |
| Binder C | 60 | 40 | 0 | 0 |
| Binder D | 60 | 40 | 0 | 10 |
| Binder E | 50 | 50 | 0 | 0 |
| Binder F | 30 | 40 | 30 | 0 |

In Table 3, the polyacrylic acid, sorbitol, and citric acid in the binder compositions are reported in parts by weight based on solids.

The mineral wool boards were then passed into a curing oven. The curing oven temperature was set to 232° C. to 287° C. (450° F. to 550° F.). The final mineral wool boards were about 76.2 mm (3 inches) thick and had densities of about 96 Kg/m³ (6 pcf).

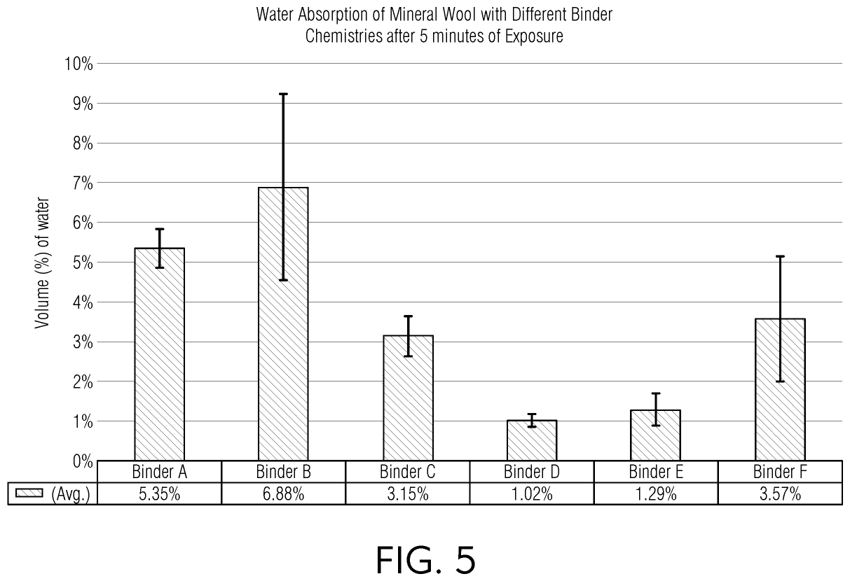

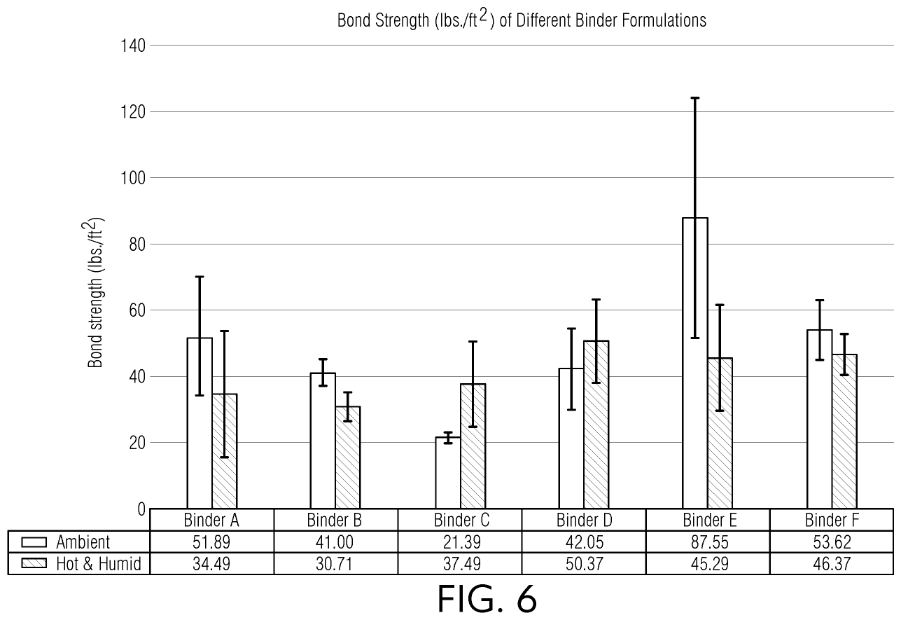

The mineral wool boards were collected and water absorption and bond strength testing were conducted in triplicate. As shown in FIG. 5, each of the binder compositions exhibited a water absorption of less than 10% without surfactant. This is important because even though the chemical composition of these binders are hydrophilic in nature, they do not provide the desired wettability for the product. Additionally, as illustrated in FIG. 6, the bond strength for each of the binder compositions was less than 90 lbs/ft², with only Binder E exhibiting a bond strength of greater than 55 lb/ft². This demonstrates that the binder alone doesn't provide the desired mechanical strength.

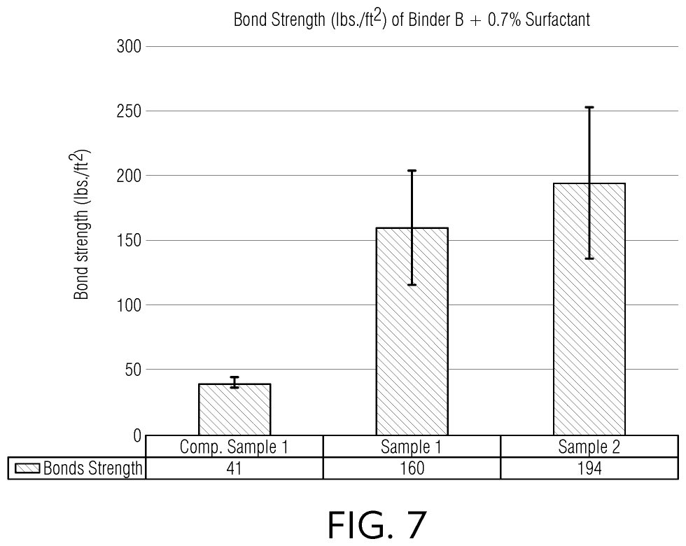

Next, to determine whether adding surfactant to the binder composition could aid in distributing the binder throughout the mineral wool fibers, 0.7 wt. % of STEP-FLOW 1500 (an ethoxylated propoxylated polyarylphenol ether (non-ionic) surfactant from Stepan) was added to Binder B. Boards including the binder including surfactant were made as described above, except for Sample 1 was cured at a curing temperature of 500° F., while Comparative Sample 1 (Binder B only; no surfactant) and Sample 2 were cured at a curing temperature of 550° F. As shown in FIG. 7, the addition of 0.7 wt. % of the non-ionic surfactant increased the bond strength for both of Samples 1 and 2 as compared to Comparative Sample 1. More specifically, comparing Sample 2 to Comparative Sample 1, which were both cured at the same temperature, the non-ionic surfactant increased the bond strength of the binder by more than four times.

### Example 2

Given the observations from Example 1, STEP-FLOW 1500 surfactant was added at 0.7 wt. % to other Binder B or Binder E. Boards including the binder including surfactant were made as described above, and cured at the temperatures reported in Table 4.

TABLE 4

| | Binder Composition | Cure Temperature (° F.) |
|---|---|---|
| Sample 3 | Binder B | 510 |
| Sample 4 | Binder B | 450 |
| Sample 5 | Binder E | 450 |
| Sample 6 | Binder E | 510 |

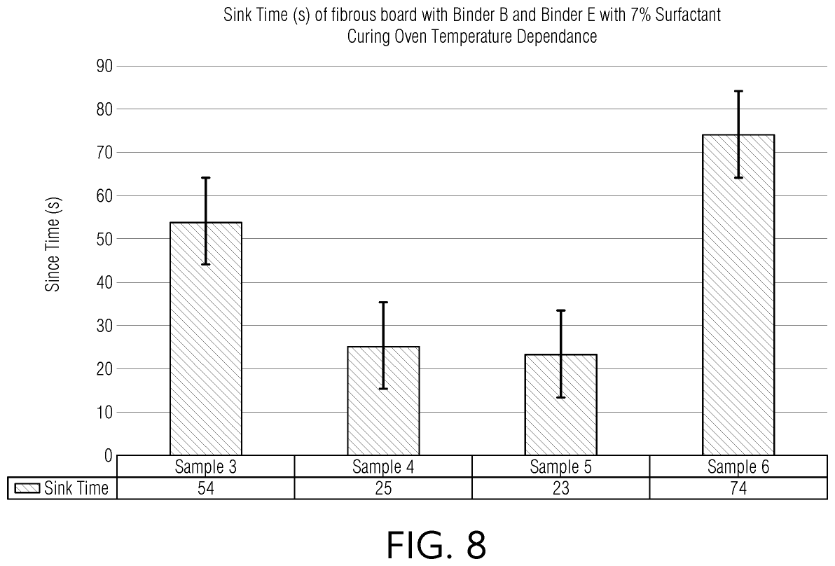

Water absorption rate, water holding capability, compression, and pressure resistance were measured for each of Samples 3-6, and the results are shown in FIGS. 8-11. Each of the cured samples had a pH between about 7.0 and about 7.6.

As shown in FIG. 8, when cured at 450° F., mineral wool boards prepared with both Binders B and E and 0.7 wt. % surfactant (Samples 4 and 5) exhibit a sink time of less than 30 seconds. However, Samples 3 and 6, which were cured at 510° F. exhibited significantly longer sink times. Therefore, it was noted that curing the fiber-based substrate products at a temperature of between about 450° F. and about 480° F. would yield suitable sink times. Notably, no smoke was observed at 510° F. Smoke typically appears at higher curing oven temperatures. In particular, with conventional PUF binders, smoke may be observed at curing temperatures greater than 480° F. In manufacturing facilities, temperature and fan settings are increased to compensate for under-cured product that can result from the oven belt clogging. However, the ability to increase temperature and fan settings is limited based on an increase in smoke. Accordingly, the lack of smoke up to 510° F. for various embodiments gives a larger window within which the settings can be adjusted to achieve a balance between manufacturing process and final product performance.

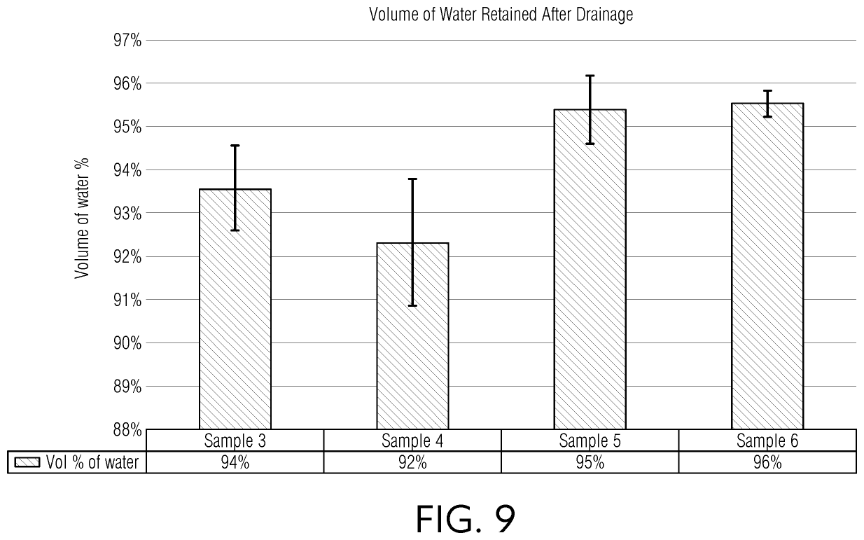

Turning to FIG. 9, the water holding capabilities of Samples 3-6 are presented. Unlike sink time, the water holding capabilities of the mineral wool boards were not impacted by curing temperature, and each of Samples 3-6 exhibited a water holding of greater than 90%. Taken with the results presented in FIG. 8, this suggests that the curing temperature affects the water absorption rate, but once the mineral wool product is saturated, it can hold the same amount of water as an otherwise identical mineral wool product cured at a different temperature. It was hypothesized that the surfactant aids the absorption rate of water, but the material porosity supports the water holding ability. Furthermore, the water holding capability of each of Samples 3-6 was similar to commercially available mineral wool products prepared using formaldehyde-containing binders.

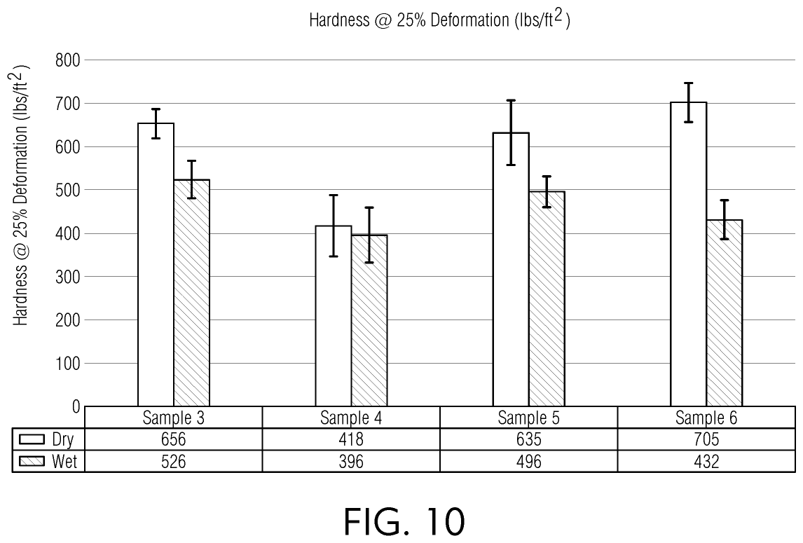

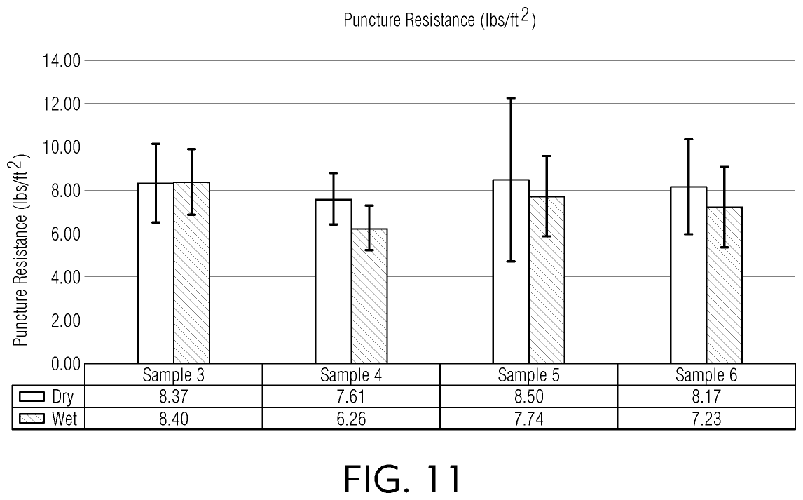

Compressive strength of the samples is presented in FIG. 10, and puncture resistance of the samples is presented in FIG. 11. Each of Samples 3-6 exhibited a compressive stress of greater than 100 lb/ft², and more particularly, greater than about 395 lb/ft², and a puncture resistance of greater than 2.5 lb/ft², and more particularly, greater than 6 lb/ft². The puncture resistance of each of Samples 3-6 was up to three times higher than the puncture resistance exhibited by mineral wool products prepared using commercially available formaldehyde-containing binders.

Given that surfactants are amphiphilic molecules (e.g., they have a hydrophilic side and a hydrophobic side), surfactants can mix with other liquids and break their intermolecular interactions, helping them spread more quickly throughout a surface. They can also adsorb at the interface of unalike molecules to provide the same effect. Knowing that the binder compositions described above are hydrophilic yet lacked a suitable sink time without the inclusion of a surfactant, surface tension of various samples was measured to confirm that the addition of the surfactant into the binder composition was the main factor in decreasing the surface tension of water as it comes into contact with the product.

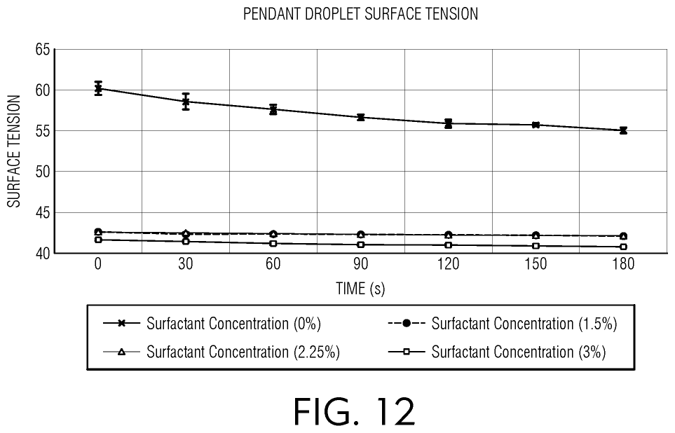

Comparative Sample 2 included a formaldehyde-free binder as described above, without surfactant added. Samples 7, 8 and 9 included STEP-FLOW 1500 surfactant in a concentration of 1.5%, 2.25%, and 3%, respectively. Surface tension was measured at a temperature between 70° F. and 75° F. and a humidity between 40% and 60% in triplicate for samples having a volume of approximately 8 μL over a time of from 0 seconds to 180 seconds (3 minutes) using the pendant drop method. The average values (in N/m) for each sample are presented in FIG. 12.

As shown in FIG. 12, an increase in the concentration of the surfactant directly corresponds to a decrease in the surface tension. Accordingly, without being bound by theory, it is believed that the surfactant improves water absorption rates and sink times of the products by reducing the surface tension.

### Example 3

To further evaluate the performance of the fiber-based substrate products in horticultural applications (e.g., as a plant substrate), growth trials were conducted using the fiber-based substrate products in accordance with embodiments herein and two commercially available mineral/stone wool products having phenol-urea formaldehyde binders. The growth trials were conducted by Summit Concentrates, a licensed, third-party marijuana cultivation facility in the state of Colorado. All samples were collected in accordance with the 2021 Colorado Department of Public Health and Environment Sampling Requirements.

The experimental design included three growing media groups evenly distributed throughout six vertical hydroponic tables in one growth room. The vertical hydroponic tables adjacent to the walls were eliminated from the study to minimize microclimates effect risk associated with the testing space. All samples were subjected to the same treatment and managed equally. The three groups included 564 plants of six different strains. The control group (Group A) included plants that were started in a VIDAWOOL™ cylindrical plug with a diameter of 1.2″ and a height of 1.5″ which were transplanted into a VIDAWOOL™ Block 190 (6″×6″×5.3″) (both commercially available from Owens Corning, Toledo, Ohio) following the cloning phase. Group B included plants that were started in another commercially available mineral/stone wool product having a phenol-urea formaldehyde binder in the form of a 1.5″ block and were transplanted into a 6″ block formed with the same binder as the 1.5″ block following the cloning phase. Group C included plants that were started in a cylindrical plug having a diameter of 1.2″ and a height of 1.5″ formed with Binder E described above and transplanted into block (6″×6″×5.3″) formed with Binder E following the cloning phase.

Each stage of plant growth requires a specific set of conditions (e.g., fertilizer, pH adjustment solution, temperature, humidity, and water/block saturation) for optimal growth performance. To account for these differences, each phase was performed in a different room. A fixed mixture of fertilizer recipes was used to irrigate the plants from a reservoir throughout an automated system. The fertilizer mixture included silicon dioxide and a mixture of critical nutrients including, but not limited to, calcium nitrate, ammonium nitrate, nitric acid, potassium hydroxide, phosphoric acid anhydride, and magnesium sulfate. PH was adjusted using a dilute sulfuric acid. Tap water from the City of Aurora was used after being filtered with a 1 μm sediment filter and an activated carbon filter.

Six Cannabis cultivars were selected for the study. All clones were obtained from mother plants. The cultivars chosen represent transect of the ranges of internodal spacing, product yield, leaf surface area, and other typical variation expected on the market and that are strain specific. The strains selected are commercially known as Apple Fritter (APP), Divine Kush Breath (DKB), Ice Cream Cake (ICC), Melon Juice (Mil), Tropical Banana (TBN), and Tropical Diesel (TOD).

During the cloning phase, all clones were covered with a humidity dome for the first 48 hours, and the humidity dome was removed for the rest of the cloning period. Temperature and relative humidity were kept constant. The cloning phase lasted approximately two weeks. The healthiest clones were selected from the group in accordance with normal cultivation practice to eliminate any potential confounding effect of genetically inferior plants on the final trial results. At the completion of the cloning stage, the plants have developed root off the plugs and get transplanted to the blocks and moved to the vegetative room.

During the vegetative stage, the temperature and relative humidity were kept constant, and air was supplemented with carbon dioxide. The vegetative stage lasted approximately six weeks.

Finally, the plants entered the flowering stage and were moved to the flowering room. The temperature and humidity levels varied, with each decreasing throughout the final stages of the growth cycle. The air was supplemented with carbon dioxide. All plants were harvested within three days. Each sample was cut at the bottom of the stem and weighed using an OHAUS™ RANGER™ 3000 bench scale to the nearest 0.1 g. Each plant was processed individually after harvest and data was captured for each individual plant until they were dried. After seven to nine days of drying, individual plants were pooled into bins after additional data capture. Bins were processed in the same manner to achieve consistent final product quality and consistency.

More specifically, for each plant, stem diameter at the base of the plant prior to harvest (from diameter), total wet weight of the above-ground portion of each plant immediately after harvest, dry usable mass (dried flowers processed for cannabinoids extraction). Statistical analysis was performed using JMP™ Pro statistical software. The results are presented in Table 5.

TABLE 5

| | Group A | | Group C |
|---|---|---|---|
| | (VIDAWOOL ™) | Group B | (Inventive) |
| Average Stem | 17.01 ± 2.02 | 17.01 ± 1.68 | 17.62 ± 1.89* |
| Diameter (mm) | | | |
| Average Wet | 1426.57 ± 321.58 | 1478.27 ± 305.02 | 1508.87 ± 311.31** |
| Weight (g) | | | |
| Dry Usable Plant | 250.19 ± 59.01 | 263.47 ± 51.44 | 265.14 ± 56.75** |
| Weight (g) | | | |

*Significantly different from both other groups.
**Significantly different from Group A, but not Group B.

As shown in Table 5, the JMP™ Pro analysis (using a one-way analysis of variance (ANOVA) test) showed a statistically significant effect (F ratio=6.8099, p=0.0012, N=564) of the growing media on the average stem diameter. Upon further analysis, using a Tukey-Kramer HSD, there was a significant difference between Group C and Groups A and B (p=0.0042). However, Groups A and B were not significantly different from one another (p=1.00).

With respect to wet weight, the ANOVA test showed a statistically significant effect (F ratio=3.3266, p=0.0366, N=564) of the growing media. Upon further analysis, using a Tukey-Kramer HSD, there was a significant difference between Group C and Group A (p=0.0295). This indicates that the growing media in accordance with various aspects described herein can increase plant biomass when compared with other commercially available growing media alternatives.

Additionally, the ANOVA test showed a statistically significant effect (F ratio=3.8242, p=0.0224, N=532) of the growing media on the dry usable plant weight. Upon further analysis, using a Tukey-Kramer HSD, there was a significant difference between Group C and Group A (p=0.0320).

Using JMP™ Pro's bivariate fit to analyze any correlation between the wet weight and dry usable plant weight, a strong correlation (R 2=0.852) was shown. As growers in the industry use the dry usable plant weight as a key metric when referring to their yield, this supports previous data indicating a statistically significant higher performance versus other commercially available mineral growing media.

Quality characteristics were also analyzed to examine performance of the growing media on the quality of the plants grown. In particular, Cannabis sativa is highly valued by users and growers aim to optimize their operation to produce high tetrahydrocannabinol (THC) concentrations and a rich terpene profile. THC is the major psychoactive component and the terpenes are the main component responsible for the plant aroma. The largest concentration of THC and terpenes is found in the trichomes, which are the resin glands that are highly accumulated in the flower and surrounding leaves. The terpene profile gives each strain of Cannabis a unique smell and taste.

Terpene concentrations were measured and analyzed using gas chromatography-mass spectrometry (GC-MS). Analysis of the weight of fifteen different terpenes in both APP and TBN plants grown in each type of growing media (N=162) showed no statistical significance on the terpene concentration across the different growing media, suggesting that there is no negative impact of the growing media described herein on the terpene profile as compared to other commercially available mineral growing media. Total terpenes for plants grown using Group A media were 20.704 mg/g, Group B were 21.232 mg/g, and Group C were 21.670 mg/g. Furthermore, total terpenes were analyzed using JMP™ Pro's ANOVA test. The analysis showed no statistically significant effect (F Ratio=1.1536, p=0.3181, N=163) of the growing media on the total terpenes. Upon further analysis, using a Tukey-Kramer HSD, there was no significant difference between Groups A-C (p=0.0320) on the total terpenes.

Cannabinoid potency of APP and TBN plants were measured and analyzed using high-performance liquid chromatography (HPLC). Potency is a measure of delta-9-tetrahydrocannabinol (THC) concentration and is often reported as a percentage by weight. THC is the psychoactive ingredient in the Cannabis plant, however the majority of THC in Cannabis exists as the precursor molecule tetrahydrocannabinolic acid (THCA), a non-psychoactive cannabinoid. Potency (% Total THC) is calculated from the concentration of both molecules, according to the following equation:

% Total THC=% THC+(% THCA×0.877).

This conversion factor accounts for the weight of CO₂ lost through thermal decarboxylation during the testing.

Potency percentage was analyzed using JMP™ Pro's ANOVA test. The analysis showed no statistically significant effect (F ratio=1.7168, p=0.1829, N=163) of the growing media on the potency percentage. In particular, Group A had a potency percentage of 19.1%, Group B had a potency percentage of 19.6%, and Group C had a potency percentage of 19.6%. Upon further analysis, using a Tukey-Kramer HSD, the data confirms that there was no significant difference between Groups A-C on the potency percentage as shown by p-values of less than 0.05.

Accordingly, analysis of the quality characteristics suggests a comparable performance of the growth media formed using a formaldehyde free binder with a non-ionic surfactant (e.g., STEP-FLOW® 1500) as compared to commercially available alternatives, demonstrating that the growth media described herein is a suitable alternative for plant growth and provides a plant of comparable quality while reducing or eliminating the presence of a chemical harmful for human consumption.

It will be appreciated that many more detailed aspects of the illustrated products and processes are in large measure, known in the art, and these aspects have been omitted for purposes of concisely presenting the general inventive concepts. Although the present invention has been described with reference to particular means, materials and embodiments, from the foregoing description, one skilled in the art can easily ascertain the essential characteristics of the present disclosure and various changes and modifications can be made to adapt the various uses and characteristics without departing from the spirit and scope of the present invention as described above and set forth in the attached claims.

What is claimed is:

1. A mineral wool plant substrate comprising mineral wool fibers bound by a binder formed from an aqueous binder composition comprising:
a cross-linking agent comprising at least two carboxylic acid groups;
a polyol component having at least two hydroxyl groups;
a nitrogen-based protective agent; and
from 0.05 wt. % to 0.7 wt. % of a non-ionic surfactant.

2. The mineral wool plant substrate according to claim 1, wherein the non-ionic surfactant comprises an ethoxylated propoxylated polyarylphenol ether.

3. The mineral wool plant substrate according to claim 1, wherein said nitrogen-based protective agent comprises at least one of an amine-based protective agent or an ammonium based protective agent.

4. The mineral wool plant substrate according to claim 1, wherein the mineral wool plant substrate is substantially free of formaldehyde.

5. The mineral wool plant substrate according to claim 1, wherein the mineral wool plant substrate has a density in the range of 30 kg/m³ to 150 kg/m³.

6. The mineral wool plant substrate according to claim 1, wherein the mineral wool plant substrate has a loss on ignition of from 1.0% to 5.0%.

7. The mineral wool plant substrate according to claim 1, wherein the mineral wool plant substrate exhibits a bond strength of from about 150 lb/ft² to about 250 lb/ft².

8. The mineral wool plant substrate according to claim 1, wherein the mineral wool plant substrate exhibits a sink time of less than 30 seconds for a 6 pcf product.

9. The mineral wool plant substrate according to claim 1, wherein the mineral wool plant substrate exhibits a water absorption of greater than 50%.

10. The mineral wool plant substrate according to claim 1, wherein the mineral wool plant substrate exhibits a compressive strength of at least 100 lb/ft².

11. The mineral wool plant substrate according to claim 1, wherein the mineral wool plant substrate exhibits a puncture resistance of at least 2.5 lb/ft².

12. A method of manufacturing a fiber-based plant substrate comprising:
collecting a plurality of inorganic fibers on a substrate;
applying an aqueous binder composition to the collection of inorganic fibers, forming binder-coated inorganic fibers, the aqueous binder composition comprising:
a crosslinking agent comprising at least two carboxylic acid groups;
a polyol component having at least two hydroxyl groups;
a nitrogen-based protective agent, wherein said nitrogen-based protective agent comprises at least one of an amine-based protective agent or an ammonium based protective agent; and
from 0.05 to 0.7 wt % of a non-ionic surfactant, based on a total weight of the aqueous binder composition;
curing the aqueous binder composition at a temperature less than 510° F., thereby forming a fiber-based plant substrate, wherein said aqueous binder composition is free of formaldehyde.

13. The method of claim 12, wherein the polyol component comprises a sugar alcohol, an alkanolamine, pentaerythritol, or mixtures thereof.

14. The method of claim 12, wherein the nitrogen-based protective agent comprises ammonium hydroxide.

15. The method of claim 12, wherein the aqueous binder composition has an uncured pH of 4.2 to 6.5.

16. The method of claim 12, wherein the non-ionic surfactant comprises an ethoxylated propoxylated polyarylphenol ether.

17. The method of claim 12, wherein the aqueous binder composition is cured at a temperature of from about 450° F. to 480° F.

18. A mineral wool plant substrate comprising mineral wool fibers bound by a binder formed from an aqueous binder composition comprising:
at least 50 wt. % of a polyacrylic acid, a salt of a polyacrylic acid, an anhydride of a polyacrylic acid, or a polyacrylic-acid based resin, based on a total weight of solids in the aqueous binder composition;
from about 5 wt. % to about 50 wt. % of a sugar alcohol, based on a total weight of solids in the aqueous binder composition;
ammonium hydroxide; and
from about 0.05 wt. % to about 0.7 wt. % of an ethoxylated propoxylated polyarylphenol ether.

19. The mineral wool plant substrate according to claim 18, wherein the mineral wool plant substrate is in the form of a plug, a block, or a slab.

20. The mineral wool plant substrate according to claim 18, wherein the mineral wool plant substrate exhibits a sink time of less than 25 seconds for a 6 pcf product, a water absorption of greater than 90%, a compressive strength of at least 400 lb/ft², and a puncture resistance of at least 7 lb/ft².
